(19) United States
(12) Patent Application Publication
(10) Pub. No.: US 2024/0005939 A1
(43) Pub. Date: Jan. 4, 2024

(54) DYNAMIC SPEECH ENHANCEMENT COMPONENT OPTIMIZATION

(71) Applicant: Microsoft Technology Licensing, LLC, Redmond, WA (US)

(72) Inventor: Ross G. CUTLER, Clyde Hill, WA (US)

(73) Assignee: Microsoft Technology Licensing, LLC, Redmond, WA (US)

(21) Appl. No.: 17/855,039

(22) Filed: Jun. 30, 2022

(51) Int. Cl. G10L 21/0216; G10L 15/16; G10L 15/06; G10L 15/22; G10L 25/21

(52) U.S. Cl. CPC G10L 21/0216; G10L 15/16; G10L 15/063; G10L 15/22; G10L 25/21; G10L 2021/02082

(57) ABSTRACT

Systems, methods, and computer-readable storage devices are disclosed for personalizing speech enhancement components without enrollment in speech communication systems. One method including: receiving audio data, the audio data including speech, and the audio data to be processed by at least one speech enhancement component; determining, without requiring a user to enroll, whether the speech of the audio data includes one or both of near-field speech and far-field speech; and changing one or more of the at least one speech enhancement component based on determining the speech of the audio data includes one or both of near-field speech and far-field speech.

### TECHNICAL HELD

The present disclosure relates to enhancement of speech by reducing echo, noise, dereverberation, etc. Specifically, the present disclosure relates to personalized speech enhancement in speech communication systems without requiring a user to enroll.

### INTRODUCTION

In speech communication systems, audio signals may be affected by echoes, background noise, reverberation, enhancement algorithms, network impairments, etc. Providers of speech communication systems in an attempt to provide optimal and reliable services to their customers may estimate a perceived quality of the audio signals. For example, speech quality prediction may be useful during network design and development as well as for monitoring and improving customers' quality of experience (QoE).

In order to improve a costumer's QoE, speech enhancement components are critical to telecommunication for reducing echo, noise, dereverberation, etc. Many of these speech enhancement components may be based on acoustic digital signal processing (ADSP) algorithms, deep learning components, and/or personalized based on specific training by customers. A problem with ADSP algorithms is that they are not personalized to individual customers. A problem with deep learning speech enhancement components is that they are only as good as the data used to train them, and the data may not be personalized to individual customers.

A benefit for personalized speech enhancement is that it is targeted to specific customers and such system may remove any sounds, including speech, that are not the customer's speech. However, certain current personalized speech enhancement components require customers to enroll and/or to train a speech enhancement component, which may take significant amounts of time, significant amounts of memory, and/or significant amounts of processing. For example, certain current personalized speech enhancement components require customers to say a few sentences to characterize their voices. A big issue with enrollment is that very few customers enroll themselves for personalized speech enhancement.

Thus, there is a need to personalized speech enhancement components without requiring enrollment, such as training, that automatically improves the QoE of customers without needing a customers active involvement.

### SUMMARY OF THE DISCLOSURE

According to certain embodiments, systems, methods, and computer-readable media are disclosed for personalized speech enhancement without enrollment in speech communication systems.

According to certain embodiments, a computer-implemented method for personalizing speech enhancement components without enrollment in speech communication systems is disclosed. One method comprising: receiving audio data, the audio data including speech, and the audio data to be processed by at least one speech enhancement component; determining, without requiring a user to enroll, whether the speech of the audio data includes one or both of near-field speech and far-field speech; and changing one or more of the at least one speech enhancement component based on determining the speech of the audio data includes one or both of near-field speech and far-field speech.

According to certain embodiments, a system for personalizing speech enhancement components without enrollment in speech communication systems is disclosed. One system including: a data storage device that stores instructions for personalizing speech enhancement components without enrollment in speech communication systems; and a processor configured to execute the instructions to perform a method including: receiving audio data, the audio data including speech, and the audio data to be processed by at least one speech enhancement component; determining, without requiring a user to enroll, whether the speech of the audio data includes one or both of near-field speech and far-field speech; and changing one or more of the at least one speech enhancement component based on determining the speech of the audio data includes one or both of near-field speech and far-field speech.

According to certain embodiments, a computer-readable storage device storing instructions that, when executed by a computer, cause the computer to perform a method for personalizing speech enhancement components without enrollment in speech communication systems is disclosed. One method of the computer-readable storage device including: receiving audio data, the audio data including speech, and the audio data to be processed by at least one speech enhancement component; determining, without requiring a user to enroll, whether the speech of the audio data includes one or both of near-field speech and far-field speech; and changing one or more of the at least one speech enhancement component based on determining the speech of the audio data includes one or both of near-field speech and far-field speech.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

In the course of the detailed description to follow, reference will be made to the attached drawings. The drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure.

Moreover, there are many embodiments of the present disclosure described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein.

FIG. 1 depicts an exemplary speech enhancement architecture of a speech communication system pipeline, according to embodiments of the present disclosure.

FIG. 2 depicts a method for training a neural network to detect near-field speech and/or far-field speech and/or for training personalized speech enhancement components using neural networks, according to embodiments of the present disclosure.

FIG. 3 depicts a method 300 for personalizing speech enhancement components without enrollment in speech communication systems, according to embodiments of the present disclosure.

FIG. 4 depicts a high-level illustration of an exemplary computing device that may be used in accordance with the systems, methods, and computer-readable media disclosed herein, according to embodiments of the present disclosure.

FIG. 5 depicts a high-level illustration of an exemplary computing system that may be used in accordance with the systems, methods, and computer-readable media disclosed herein, according to embodiments of the present disclosure.

Again, there are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION OF EMBODIMENTS

One skilled in the art will recognize that various implementations and embodiments of the present disclosure may be practiced in accordance with the specification. All of these implementations and embodiments are intended to be included within the scope of the present disclosure.

As used herein, the terms “comprises,” “comprising,” “have,” “having,” “include,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” Additionally, the term “or” is intended to mean an inclusive “or” rather than an exclusive “or.” That is, unless specified otherwise, or clear from the context, the phrase “X employs A or B” is intended to mean any of the natural inclusive permutations, For example, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

For the sake of brevity, conventional techniques related to systems and servers used to conduct methods and other functional aspects of the systems and servers (and the individual operating components of the systems) may not be described in detail herein. Furthermore, the connecting lines shown in the various figures contained herein are intended to represent exemplary functional relationships and/or physical couplings between the various elements. It should be noted that many alternative and/or additional functional relationships or physical connections may be present in an embodiment of the subject matter.

Reference will now be made in detail to the exemplary embodiments of the disclosure, examples of which are illustrated in the accompanying drawings. Wherever possible, the same reference numbers will be used throughout the drawings to refer to the same or like parts.

The present disclosure generally relates to, among other things, a methodology to personalized enhancement components without enrollment by using machine learning to improve QoE in speech communication systems. There are various aspects of speech enhancement that may be improved through the use of a personalized speech enhancement components, as discussed herein.

Embodiments of the present disclosure provide a machine learning approach which may be used to personalized speech enhancement components of a speech communication system. In particular, neural networks may be used as the machine learning approach. The approach of embodiments of the present disclosure may be based on training one or more neural networks to detect certain types of speech, and then change speech enhancements components of speech communication systems to personalized speech enhancement components based on detecting the certain types of speech. Neural networks that may be used include, but not limited to, deep neural networks, convolutional neural networks, recurrent neural networks, etc.

Non-limiting examples of speech enhancement components that may be personalized using a trained neural network include one or more of acoustic echo cancelation, noise suppression, dereverberation, automatic gain control, etc. For example, a personalized noise suppression component may remove all noise and speech other than a user's own speech, and a personalized automatic gain control may activate when the user's own speech is detected.

Neural networks may be trained using datasets. For example, such datasets may include datasets including audio data of noise, datasets including audio data of clean speech, and datasets including audio data of room responses. These datasets may be combined to create noisy speech, and then a neural network may be trained to remove everything except human speech. Moreover, datasets may include audio data of one or both of near-field speech and/or far-field speech. Far-field speech being speech spoken by a user from a far distance, e.g., greater or equal to than 0.5 m, to a receiving device, i.e., microphone. Near-field speech being speech spoken by a user from a near distance, e.g., less than 0.5, to the receiving device, i.e., microphone. More specifically, near-field speech may be speech captured by a personal endpoint (device), and far-field speech may be speech that is not captured by the personal endpoint. In certain embodiments, datasets using only near-field speech as clean speech and adding far-field speech, as a distractor (noise) may be used to train one or more neural networks.

In embodiments of the present disclosure, when a user is determined to be wearing a headset, using a handset, using earbuds, and/or using any personal endpoint (device) that captures near-field sound, or when one or more neural networks trained to detect near-field detects near-field speech, one or more speech enhancement components may be changed to corresponding personalized speech enhancement components. Thus, the user is not required to enroll, i.e., go through a personalized training process with pretrained data. Because the device of the user is a personal endpoint or because the user is determined to be near the personal endpoint, there is no harm suppressing far-field speech.

Moreover, neural networks may use various speech enhancement components, such as, acoustic echo cancelation, noise suppression, dereverberation, automatic gain control, etc., and one or more of the above-identified datasets to create personalized speech enhancement components using the below-described model creation, model validation, and model utilization techniques. For example, a neural network may use a noise suppression technology and be trained to remove noises as well as far-field speech.

Those skilled in the art will appreciate that neural networks may be constructed in regard to a model and may include phases: model creation (neural network training), model validation (neural network testing), and model utilization (neural network evaluation), though these phases may not be mutually exclusive. According to embodiments of the present disclosure, neural networks may be implemented through training, testing, and evaluation stages. Input samples of the above-described audio data may be utilized, along with corresponding ground-truth labels for neural network training and testing. For a baseline neural network, the model may have input layer of a predetermined number of neurons, at least one intermediate (hidden) layer each of another predetermined number of neurons, and an output layer having yet another predetermined number of neurons.

At least one server may execute a machine learning component of the audio processing system described herein, As those skilled in the art will appreciate, machine learning may be conducted in regard to a model and may include at least three phases: model creation, model validation, and model utilization, though these phases may not be mutually exclusive. As discussed in more detail below, model creation, validation, and utilization may be on-going processes of machine learning.

For machine learning, the model creation phase may involve extracting features from a training dataset. The machine learning component may monitor the ongoing audio data to extract features. As those skilled in the art will appreciate, these extracted features and/or other data may be derived from machine learning techniques on large quantities of data collected over time based on patterns. Based on the observations of this monitoring, the machine learning component may create a model a set of rules or heuristics) for extracting features from audio data. The baseline neural network may be trained to, for example, minimize a classification error and/or minimize squared error between around-truth and predicted labels.

During a second phase of machine learning; the created model may be validated for accuracy. During this phase, the machine learning component may monitor a test dataset, extract features from the test dataset, and compare those extracted features against predicted labels made by the model. Through continued tracking and comparison of this information and over a period of time, the machine learning component may determine whether the model accurately identifies near-field speech and far-field speech. This validation is typically expressed in terms of accuracy: i.e., what percentage of the time does the model predict the correct labels, such as, for example, near-field speech and far-field speech. Information regarding the success or failure of the predictions by the model may be fed back to the model creation phase to improve the model and, thereby, improve the accuracy of the model.

During the inference phase, additional data from a test dataset may be applied to the trained baseline neural network to generate the predicted labels. The predicted labels may then be compared with the ground-truth labels to compute performance metrics including mean-square error.

A third phase of machine learning may be based on a model that is validated to a predetermined threshold degree of accuracy, For example, a model that is determined to have at least a 90% accuracy rate may be suitable for the utilization phase. According to embodiments of the present disclosure, during this third, utilization phase, the machine learning component may extract features from audio data where the model suggests a classification of near-field speech or far-field speech of the audio data. Upon classifying a type of speech in the audio data, the model outputs the classification and may store the classification as segments of data. Of course, information based on the confirmation or rejection of the various stored segments of data may be returned back to the previous two phases (validation and creation) as data to be used to refine the model in order to increase the model's accuracy. 100% accuracy may not be necessary, and a user interface may be shown to the user that shows that a personalized microphone capture mode is enable. If personalized speech enhancement components are not to be used, a user may easily see that it is in the personalized microphone capture mode, and change it to non-personalized mode.

As mentioned above, neural networks may use various speech enhancement components, such as, acoustic echo cancelation, noise suppression, dereverberation, automatic gain control, etc., and one or more of the above-identified datasets to create personalized speech enhancement components using the above-described model creation, model validation, and model utilization techniques. For example, a neural network may use a noise suppression technology and be trained to remove noises as well as far-field speech and produce a personalized noise suppressor.

Combining the above, embodiments of the present disclosure provide personalized speech enhancement components that may be used without the requirement of enrollment for speech communication systems. One solution may be to dynamically select one or more speech enhancement components that are created using neural networks trained to identify and remove far-field speech when one or both of a personal endpoint is detected and/or near-filed speech is detected in received audio data.

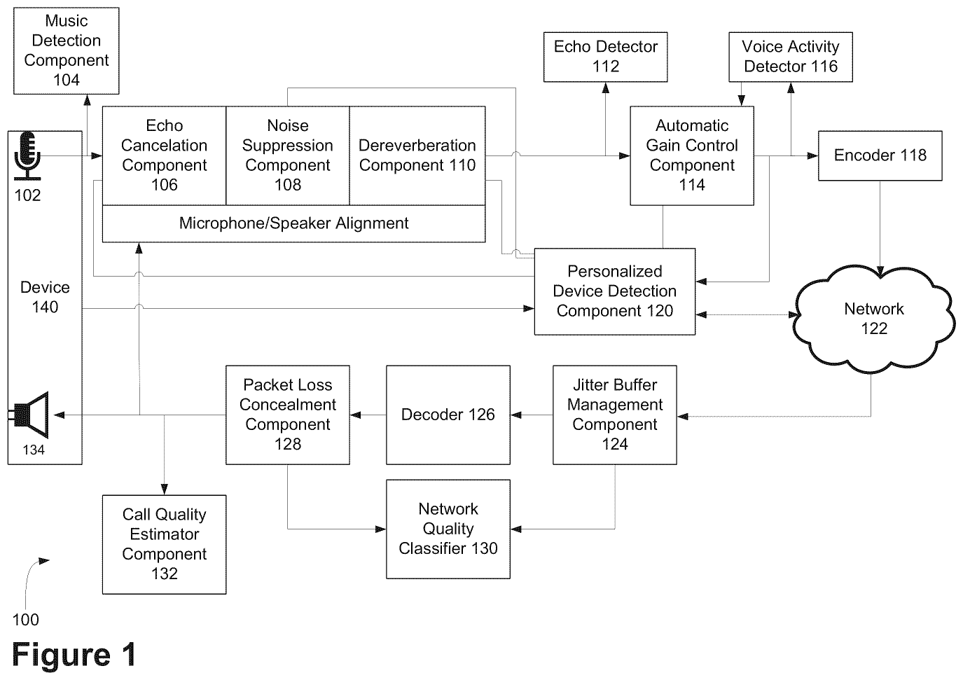

FIG. 1 depicts an exemplary speech enhancement architecture 100 of a speech communication system pipeline, according to embodiments of the present disclosure. Specifically, FIG. 1 depicts speech communication system pipeline having a plurality of speech enhancement components. As shown in FIG. 1, a microphone 102 of a device 140 may capture audio data including, among other things, speech of a user of the communication system. The audio data captured by microphone 102 may be processed by one or more speech enhancement components of the speech enhancement architecture 100. Non-limiting examples of speech enhancement components include music detection, acoustic echo cancelation, noise suppression, dereverberation, echo detection, automatic gain control, voice activity detection, jitter buffer management, packet loss concealment, etc.

FIG. 1 depicts the audio data being received by a music detection component 104 that may detect whether music is being detected in the captured audio data. For example, if audio data is detected by the music detection component 104, then the music detection component 104 may notify the user that music has been detected and/or turn off the music, The audio data captured by microphone 102 may also be received and processed by one or more other speech enhancement components, such as, e.g., echo cancelation component 106, noise suppression component 108, and/or dereverberation component 110. One or more of echo cancelation component 106, noise suppression component 108, and/or dereverberation component 110 may be speech enhancement components that provide microphone and speaker alignment, such as microphone 101 and speaker 134 of device 140. Echo cancelation component 106, also referred to as acoustic echo cancelation component, may receive audio data captured by microphone 102 as well as speaker data played by speaker 134. Echo cancelation component 106 may be used to cancel acoustic feedback between speaker 134 and microphone 102 in speech communication systems.

Noise suppression component 108 may receive audio data captured by microphone 102 as well as speaker data played by speaker 134. Noise suppression component 108 may process the audio data and speaker data to isolate speech from other sounds and music during playback. For example, when microphone 102 is turned on, background noise around the user such as shuffling papers, slamming doors, barking dogs, etc. may distract other users. Noise suppression component 108 may remove such noises around the user in speech communication systems.

Dereverberation component 110 may receive audio data captured by microphone 102 as well as speaker data played by speaker 134. Dereverberation component 110 may process the audio data and speaker data to remove effects of reverberation, such as reverberant sounds captured up by microphones including microphone 102.

The audio data, after being processed by one or more speech enhancement components, such as one or more of echo cancelation component 106, noise suppression component 108, and/or dereverberation component 110, may be speech enhanced audio data, and further processed by one or more other speech enhancement components. For example, the speech enhanced audio data may be received and/or processed by one or more of echo detector 112 and/or automatic gain control component 114. Echo detector 112 may use the speech enhanced audio data to detect whether echoes are present in the speech enhanced audio data, and notify the user of the echo. Automatic gain control component 114 may use the speech enhanced audio data to amplify and/or increase the volume of the speech enhanced audio data based on whether speech is detected by voice activity detector 116.

Voice activity detector 116 may receive the speech enhanced audio data having been processed by automatic gain control component 114 and may detect whether voice activity is detected in the speech enhanced audio data, Based on the detections of voice activity detector 116, the user may be notified that he or she is speaking while muted, automatically turn on or off notifications, and/or instruct automatic gain control component 114 to amplify and/or increase the volume of the speech enhanced audio data.

The speech enhanced audio data may then be received by encoder 118. Encoder 118 may be an audio codec, such as an AI-powered audio codec, e.g., SATIN encoder, which is a digital signal processor with machine learning. Encoder 118 may encode (i.e., compress) the audio data for transmission over network 122. Upon encoding, encoder 118 may transmit the encoded speech enhanced audio data to the network 122 where other components of the speech communication system are provided. The other components of the speech communication system speech may then transmit over network 122 audio data of the user and/or other users of the speech communication system.

A jitter buffer management component 124 may receive the audio data that is transmitted over network 122 and process the audio data. For example, jitter buffer management component 124 may buffer packets of the audio data in order to allow decoder 126 to receive the audio data in evenly spaced intervals. Because the audio data is transmitted over the network 122, there may be variations in packet arrival time, i.e., jitter, that may occur because of network congestion, timing drift, and/or route changes. The jitter buffer management component 124, which is located at a receiving end of the speech communication system, may delay arriving packets so that the user experiences a clear connection with very little sound distortion.

The audio data from the jitter buffer management component 124 may then be received by decoder 126. Decoder 126 may be an audio codec, such as an AI-powered audio codec, e.g., SATIN decoder, which is a digital signal processor with machine learning. Decoder 126 may decode (i.e., decompress) the audio data received from over the network 122. Upon decoding, decoder 126 may provide the decoded audio data to packet loss concealment component 128.

Packet loss concealment component 128 may receive the decoded audio data and may process the decoded audio data to hide of gaps in audio streams caused by data transmission failures in the network 122. The results of the processing may be provided to one or more of network quality classifier 130, call quality estimator component 132, and/or speaker 134.

Network quality classifier 130 may classify a quality of the connection to the network 122 based on information received from jitter buffer management component 124 and/or packet loss concealment component 128, and network quality classifier 130 may notify the user of the quality of the connection to the network 122, such as poor, moderate, excellent, etc. Call quality estimator component 132 may estimate the quality of a call when the connection to the network 122 is through a public switched telephone network (PSTN). Speaker 134 may play the decoded audio data as speaker data. The speaker data may also be provided to one or more of echo cancelation component 106, noise suppression component 108, and/or dereverberation component 110. Device 140 may include one or both of microphone 102 and/or speaker 134, for example, device 140 may be, among other things, a combined microphone and speaker such a headset, handset, conference call device, smart speaker, etc., and/or device 140 a microphone separate and distinct speaker.

Speech enhanced audio data may be received and/or audio data including speech from microphone 102 of device 140 and/or speaker data of speaker 134 of device 140 may also be received by personalized device detection component 120. Moreover, personalized device detection component 120 may be connected to, directly or indirectly, one or more speech enhancement components, such as echo cancelation component 106, noise suppression component 108, dereverberation component 110, automatic gain control component 114, etc. Personalized device detection component 120 may additionally/optionally receive information from one or more speech enhancement components to determine one or more speech enhancement components is being used. Additionally, personalized device detection component 120 transmit to one or more speech enhancement components an indication to change a corresponding one or more speech enhancement components to a different one or more speech enhancement components, and/or transmit particular one or more speech enhancement components to be used.

As mentioned above, personalized device detection component 120 may receive information about the device 140, and the information about the microphone 102 may be used to determine whether is near-field speech or far-field speech is being captured by the device 140. For example, if the information about the device 140 indicates that a personal device is being used, then personalized device detection component 120 may determine that a personalized device, i.e., device 140 is capturing audio data that is near-field speech. As mentioned above, a personal device includes a personal audio device, such as, e.g., a headset, handset, earbuds, etc, In other words, a personal audio device is a device meant for individual usage only on the near end Conversely, a non-personal audio device may include a speakerphone, which is meant for use by a group of individuals. The audio data from the personal device may be likely to have a high signal to noise ratio and low reverberation. Thus, personalized device detection component 120 may determine whether the audio data is near-field speech or far-field speech.

Additionally, and/or alternatively, personalized device detection component 120 may be one or more of neural networks trained to determine whether the audio data and/or speech enhanced audio data is near-field speech or far-field speech. The one or more of the trained neural networks of personalized device detection component 120 may determine whether the audio data is near-field speech or far-field speech. Both determining whether audio data is near-field speech or far-field speech through one or both of information about device 140 and/or through the use of a trained neural network does not require user enrollment.

Additionally, and/or alternative, personalized device detection component 120 may determine whether the audio data includes near-field speech using a reverberation time 60 (RT60) metric. The RT60 metric being defined as a measure of the time after speech of the audio data ceases that it takes for a sound pressure level to reduce by 60 dB. In addition to the RT60 metric, Signal to Noise ratio of greater than 40 dB for a near-field device, and/or speech-to-reverberation modulation energy ratio (SRMR) may be used.

Thus, the personalized device detection component 120 may determine, without requiring a user to enroll, whether the speech of the audio data includes one or both of near-field speech and far-field speech. For example, depending on a use case, if a personal device is determined to be in use, far-field speech may be removed. For a non-personal device, far-field speech is not removed. Upon determining the speech of the audio data includes one or both of near-field speech and far-field speech, the personalized device detection component 120 may change the one or more of the at least one speech enhancement component based on the determination. For example, the personalized device detection component 120 may change one or more of the speech enhancement components to one or more speech enhancement components having been trained with near-field speech as clean speech and far-field speech as distractors. In particular, when the speech of the audio data includes either only near-field speech, or both near-field and far-field speech, each of the one or more speech enhancement components may be changed to corresponding personalized speech enhancement components. For example, each of acoustic echo cancelation component, noise suppression component, dereverberation component, and automatic gain control may be changed to a corresponding personalized acoustic echo cancelation component, personalized noise suppression component, personalized dereverberation component, and personalized automatic gain control. Additionally, and/or alternatively, each of the changed corresponding personalized speech enhancement components may be a corresponding neural network model having been trained using far-field speech. The personalized speech enhancement component using the trained neural network model is a personalized noise suppression component using datasets of only near-field speech as clean speech and adding datasets of only far-field speech as a distractor to train a personalized noise suppression component neural network to noise suppress far-field speech.

When the speech of the audio data is determined to include only far-field speech and/or when a non-personal device is detected, the one or more speech enhancement components may remain the same and/or changed by the personalized device detection component 120 to corresponding speech enhancement components that do not remove far-field speech.

Based on the results of the personalized device detection component 120, the one or more speech enhanced components may dynamically and/or in real time change the various personalized speech enhancement components, such as echo cancelation component 106, noise suppression component 108, dereverberation component 110, automatic gain control component 114, jitter buffer management component 124, and/or packet loss concealment component 128.

Additionally, and/or alternatively, the one or more speech enhancement components that improve speech may be reported back to a server over the network by personalized device detection component 120, along with a make and/or model of the device with the improved speech enhancement. In turn, the server may aggregate such reports from a plurality of devices from a plurality of users, and the one or more speech enhancement components may be used in systems with the same make and/or model of the reporting device. Alternatively, the personalized device detection component 120 reside over the network 122 and/or in a cloud, and communicate over the network to one or more of the speech enhancement components of the speech enhancement architecture 100 of the speech communication system pipeline,

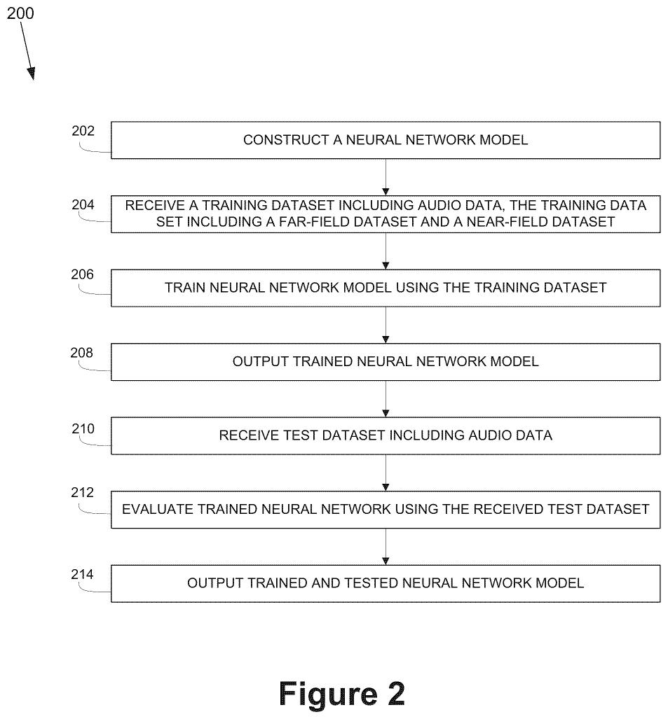

FIG. 2 depicts a method 200 for training a neural network to detect near-field speech and/or far-field speech and/or for training personalized speech enhancement components using neural networks, according to embodiments of the present disclosure. Method 200 may begin at 202, in which a neural network model may be constructed and/or received according to a set of instructions. The neural network model may include a plurality of neurons. The neural network model may be configured to output a classification of audio data as near-field speech and/or far-field speech and/or to output features of respective personalized speech enhancement components based on whether the speech includes near-field speech and/or far-field speech. The plurality of neurons may be arranged in a plurality of layers, including at least one hidden layer, and may be connected by connections. Each connection including a weight. The neural network model may comprise, for example, a convolutional neural network model.

Then, at 204, a training data set may be received. The training data set may include audio data. The audio data may include only near-field speech as clean speech and adding far-field speech, as a distractor (noise). Near-field speech may be speech captured by a personal endpoint (device), and far-field speech may be speech that is not captured by the personal endpoint. Thus, for personalized speech enhancement a far-field dataset and near-field dataset may be used, the far-field dataset being sounds to remove for noise suppression and/or sounds to be ignore for automatic gain control. However, embodiments of the present disclosure are not necessarily limited to audio data, and may include, e.g., video data having audio data.

At 206, the neural network model may be trained using the training data set. Then, at 208, the trained neural network model may be outputted. The trained neural network model may be used to output predicted label for audio data, such as near-field speech and/or far-field speech, and/or the trained neural network model may be a trained personalized speech enhancement component using neural networks. The trained deep neural network model may include a plurality of neurons arranged in the plurality of layers, including the at least one hidden layer, and may be connected by connections. Each connection may include a weight. In certain embodiments of the present disclosure, the neural network may comprise one of one hidden layer, two hidden layers, three hidden layers, and four hidden layers.

At 210, a test data set may be received. Alternatively, and/or additionally, a test data set may be created. Further, embodiments of the present disclosure are not necessarily limited to audio data. For example, the test data set may include one or more of video data including audio content.

Then, at 212, the trained neural network may then be tested for evaluation using the test data set. Further, once evaluated to pass a predetermined threshold, the trained neural network may be utilized. Additionally, in certain embodiments of the present disclosure, the step of method 200 may be repeated to produce a plurality of trained neural networks. The plurality of trained neural networks may then be compared to each other and/or other neural networks. Alternatively, 210 and 212 may be omitted. Then, the trained and tested neural network model may be output at 214.

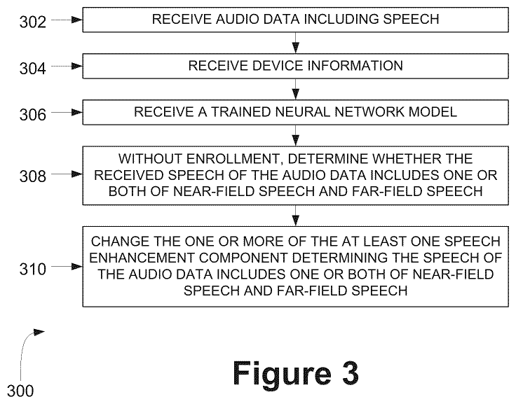

FIG. 3 depicts a method 300 for personalizing speech enhancement components without enrollment in speech communication systems, according to embodiments of the present disclosure. The method 300 may begin at 302, in which audio data including speech may be received. The audio data having been processed by at least one speech enhancement component. As mentioned above, the at least one speech enhancement component may include one or more of acoustic echo cancelation, noise suppression, dereverberation, automatic gain control, etc. In addition to receiving the audio data, one or more of device information of a device that captured the audio data of the device that captured the audio data may be received at 304.

Additionally, before, after, and/or during receiving the audio data, device information, a trained neural network, the neural network trained to detect whether speech of audio data is near-field speech or far-field speech may be received at 306. For example, each personalized speech enhancement components being a neural network model having been trained using far-field speech. In particular, for example, a personalized noise suppression component using datasets of only near-field speech as clean speech and adding datasets of only far-field speech as a distractor to train a personalized noise suppression component neural network to noise suppress far-field speech. Additionally, after and/or during receiving the trained neural network, one or more personalized speech enhancement components using trained neural network model may be received. In one embodiment, the one or more personalized speech enhancement components may be received at step 310 below.

Then, at 308, without any user enrollment and/or requiring user involvement, it may be determined whether the received speech of the audio data includes one or both of near-field speech and far-field speech. In an embodiment, the determination may be made by one or both of determining whether the audio data is captured using a personalized device based on the received device information, and determining whether the audio data includes near-field speech using a trained neural network that may have been previously received. Alternatively, and/or additionally, rather than using a trained neural network, determining whether the audio data includes near-field speech may be done by using a reverberation time 60 (RT60) metric. The RT60 metric being defined as a measure of the time after speech of the audio data ceases that it takes for a sound pressure level to reduce by 60 dB.

Next, at 310, one or more of the at least one speech enhancement component may be changed based on determining the speech of the audio data includes one or both of near-field speech and far-field speech. In particular one or more of the at least one speech enhancement components may be changed to one or more speech enhancement components having been trained with near-field speech as clean speech and far-field speech as distractors. Additionally, and/or alternatively, when the speech of the audio data includes either only near-field speech or near-field and far-field speech, each of the one or more of the at least one speech enhancement components may be changed to corresponding personalized speech enhancement components. When the speech of the audio data includes only far-field speech, each of the one or more of the at least one speech enhancement components may be kept the same or may be changed to corresponding speech enhancement components that do not remove far-field speech. the changed one or more of the at least one speech enhancement component includes one or more of acoustic echo cancelation, noise suppression, dereverberation, automatic gain control, etc.

Detecting the use of personalized speech enhancement components may be done by inspecting the user device for changes in speech enhancement components without user involvement. Additionally, looking at network packets to see if something is downloaded other than audio data, or determine whether quality of speech telecommunication system suddenly improves with no active steps by the user.

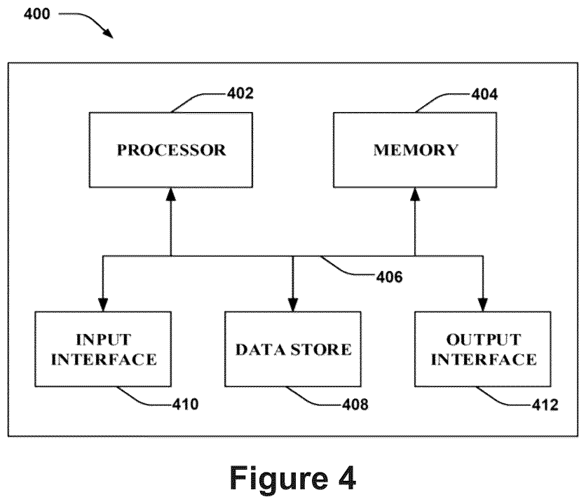

FIG. 4 depicts a high-level illustration of an exemplary computing device 400 that may be used in accordance with the systems, methods, modules, and computer-readable media disclosed herein, according to embodiments of the present disclosure. For example, the computing device 400 may be used in a system that processes data, such as audio data, using a neural network, according to embodiments of the present disclosure. The computing device 400 may include at least one processor 402 that executes instructions that are stored in a memory 404. The instructions may be, for example, instructions for implementing functionality described as being carried out by one or more components discussed above or instructions for implementing one or more of the methods described above. The processor 402 may access the memory 404 by way of a system bus 406. In addition to storing executable instructions, the memory 404 may also store data, audio, one or more neural networks, and so forth.

The computing device 400 may additionally include a data store, also referred to as a database, 408 that is accessible by the processor 402 by way of the system bus 406. The data store 408 may include executable instructions, data, examples, features, etc. The computing device 400 may also include an input interface 410 that allows external devices to communicate with the computing device 400. For instance, the input interface 410 may be used to receive instructions from an external computer device, from a user, etc. The computing device 400 also may include an output interface 412 that interfaces the computing device 400 with one or more external devices. For example, the computing device 400 may display text, images, etc. by way of the output interface 412.

It is contemplated that the external devices that communicate with the computing device 400 via the input interface 410 and the output interface 412 may be included in an environment that provides substantially any type of user interface with which a user can interact. Examples of user interface types include graphical user interfaces, natural user interfaces, and so forth. For example, a graphical user interface may accept input from a user employing input device(s) such as a keyboard, mouse, remote control, or the like and may provide output on an output device such as a display. Further, a natural user interface may enable a user to interact with the computing device 400 in a manner free from constraints imposed by input device such as keyboards, mice, remote controls, and the like. Rather, a natural user interface may rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 400 may be a distributed system. Thus, for example, several devices may be in communication by way of a network connection and may collectively perform tasks described as being performed by the computing device 400.

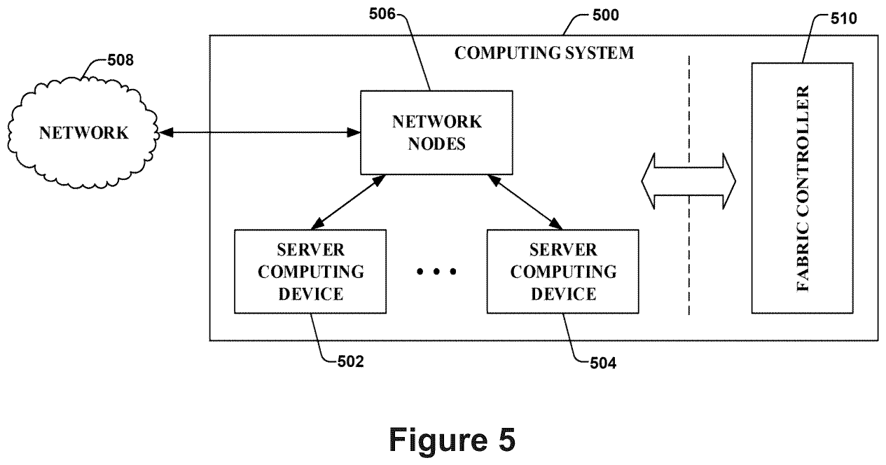

Turning to FIG. 5, FIG. 5 depicts a high-level illustration of an exemplary computing system 500 that may be used in accordance with the systems, methods, modules, and computer-readable media disclosed herein, according to embodiments of the present disclosure. For example, the computing system 500 may be or may include the computing device 400. Additionally, and/or alternatively, the computing device 400 may be or may include the computing system 500.

The computing system 500 may include a plurality of server computing devices, such as a server computing device 502 and a server computing device 504 (collectively referred to as server computing devices 502-504), The server computing device 502 may include at least one processor and a memory; the at least one processor executes instructions that are stored in the memory. The instructions may be, for example, instructions for implementing functionality described as being carried out by one or more components discussed above or instructions for implementing one or more of the methods described above. Similar to the server computing device 502, at least a subset of the server computing devices 502-504 other than the server computing device 502 each may respectively include at least one processor and a memory. Moreover, at least a subset of the server computing devices 502-504 may include respective data stores.

Processor(s) of one or more of the server computing devices 502-504 may be or may include the processor, such as processor 402. Further, a memory (or memories) of one or more of the server computing devices 502-504 can be or include the memory, such as memory 404. Moreover, a data store (or data stores) of one or more of the server computing devices 502-504 may be or may include the data store, such as data store 408.

The computing system 500 may further include various network nodes 506 that transport data between the server computing devices 502-504. Moreover, the network nodes 506 may transport data from the server computing devices 502-504 to external nodes (e.g., external to the computing system 500) by way of a network 508. The network nodes 502 may also transport data to the server computing devices 502-504 from the external nodes by way of the network 508. The network 508, for example, may be the Internet, a cellular network, or the like. The network nodes 506 may include switches, routers, load balancers, and so forth.

A fabric controller 510 of the computing system 500 may manage hardware resources of the server computing devices 502-504 (e.g., processors, memories, data stores, etc. of the server computing devices 502-504). The fabric controller 510 may further manage the network nodes 506. Moreover, the fabric controller 510 may manage creation, provisioning, de-provisioning, and supervising of managed runtime environments instantiated upon the server computing devices 502-504.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein may be implemented in hardware, software, or any combination thereof. If implemented in software, the functions may be stored on and/or transmitted over as one or more instructions or code on a computer-readable medium. Computer-readable media may include computer-readable storage media. A computer-readable storage media may be any available storage media that may be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, may include compact disc (“CD”), laser disc, optical disc, digital versatile disc (″DVD″), floppy disk, and Blu-ray disc (“BD”), where disks usually reproduce data magnetically and discs usually reproduce data optically with lasers. Further, a propagated signal is not included within the scope of computer-readable storage media. Computer-readable media may also include communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio and microwave are included in the definition of communication medium. Combinations of the above may also be included within the scope of computer-readable media.

Alternatively, and/or additionally, the functionality described herein may be performed, at least in part, by one or more hardware logic components. For example, and without limitation, illustrative types of hardware logic components that may be used include Field-Programmable Gate Arrays (“FPGAs”), Application-Specific Integrated Circuits (“ASICs”), Application-Specific Standard Products (“ASSPs”), System-on-Chips (“SOCs”), Complex Programmable Logic Devices (“CPLDs”), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A computer-implemented method for personalizing speech enhancement components without enrollment in speech communication systems, the method comprising:
receiving audio data, the audio data including speech, and the audio data to be processed by at least one speech enhancement component;
determining, without requiring a user to enroll, whether the speech of the audio data includes one or both of near-field speech and far-field speech; and
changing one or more of the at least one speech enhancement component based on determining the speech of the audio data includes one or both of near-field speech and far-field speech.

2. The method according to claim 1, wherein changing the one or more of the at least one speech enhancement component includes:
changing the one or more of the at least one speech enhancement components to one or more speech enhancement components having been trained with near-field speech as clean speech and far-field speech as distracters.

3. The method according to claim 1, wherein changing one or more of the at least one speech enhancement component includes:
when the speech of the audio data includes either i) only near-field speech or ii) near-field and far-field speech, changing each of the one or more of the at least one speech enhancement components to corresponding personalized speech enhancement components; and
when the speech of the audio data includes only far-field speech, changing each of the one or more of the at least one speech enhancement components to corresponding speech enhancement components that do not remove far-field speech.

3. The method according to claim 2, wherein each of the corresponding personalized speech enhancement components being a neural network model having been trained using far-field speech.

4. The method according to claim 3, wherein the personalized speech enhancement component using the trained neural network model is a personalized noise suppression component using datasets of only near-field speech as clean speech and adding datasets of only far-field speech as a distractor to train a personalized noise suppression component neural network to noise suppress far-field speech.

5. The method according to claim 1, wherein determining whether the speech of the audio data includes one or both of near-field speech and far-field speech includes:
one or both of i) determining whether the audio data is captured using a personalized device, and ii) determining whether the audio data includes near-field speech using a trained neural network.

6. The method according to claim 5, further comprising:
receiving the trained neural network, the neural network trained to detect whether speech of audio data is near-field speech or far-field speech,
wherein determining whether the speech of the audio data includes one or both of near-field speech and far-field speech includes:
determining whether the audio data includes near-field speech using the trained neural network.

7. The method according to claim 5, further comprising:
receiving device information of a device that captured the audio data,
wherein determining whether the speech of the audio data includes one or both of near-field speech and far-field speech includes:
determining whether the audio data is captured using a personalized device based on the received device information.

8. The method according to claim 1, wherein determining whether the speech of the audio data includes one or both of near-field speech and far-field speech includes
determining whether the audio data includes near-field speech using one or more of i) a reverberation time 60 (RT60) metric, the RT60 metric being defined as a measure of the time after speech of the audio data ceases that it takes for a sound pressure level to reduce by 60 dB, ii) signal to noise ratio of greater than 40 dB, and iii) speech-to-reverberation modulation energy ratio (SRMR).

9. The method according to claim 1, wherein the changed one or more of the at least one speech enhancement component includes one or more of acoustic echo cancelation, noise suppression, dereverberation, and automatic gain control.

10. A system for personalizing speech enhancement components without enrollment in speech communication systems, the system including:
a data storage device that stores instructions for personalizing speech enhancement components without enrollment in speech communication systems; and
a processor configured to execute the instructions to perform a method including:
receiving audio data, the audio data including speech, and the audio data to be processed by at least one speech enhancement component;
determining, without requiring a user to enroll, whether the speech of the audio data includes one or both of near-field speech and far-field speech; and
changing one or more of the at least one speech enhancement component based on determining the speech of the audio data includes one or both of near-field speech and far-field speech.

11. The system according to claim 10, wherein changing the one or more of the at least one speech enhancement component includes:
changing the one or more of the at least one speech enhancement components to one or more speech enhancement components having been trained with near-field speech as clean speech and far-field speech as distracters.

12. The system according to claim 10, wherein changing one or more of the at least one speech enhancement component includes:
when the speech of the audio data includes either i) only near-field speech or ii) near-field and far-field speech, changing each of the one or more of the at least one speech enhancement components to corresponding personalized speech enhancement components; and
when the speech of the audio data includes only far-field speech, changing each of the one or more of the at least one speech enhancement components to corresponding speech enhancement components that do not remove far-field speech.

13. The system according to claim 11, wherein each of the corresponding personalized speech enhancement components being a neural network model having been trained using far-field speech.

14. The system according to claim 13, wherein the personalized speech enhancement component using the trained neural network model is a personalized noise suppression component using datasets of only near-field speech as clean speech and adding datasets of only far-field speech as a distractor to train a personalized noise suppression component neural network to noise suppress far-field speech.

15. The system according to claim 10, wherein determining whether the speech of the audio data includes one or both of near-field speech and far-field speech includes:
one or both of i) determining whether the audio data is captured using a personalized device, and ii) determining whether the audio data includes near-field speech using a trained neural network.

16. The system according to claim 15, wherein the processor is further configured to execute the instructions to perform the method including:
receiving the trained neural network, the neural network trained to detect whether speech of audio data is near-field speech or far-field speech,
wherein determining whether the speech of the audio data includes one or both of near-field speech and far-field speech includes:
determining whether the audio data includes near-field speech using the trained neural network.

17. The system according to claim 15, wherein the processor is further configured to execute the instructions to perform the method including:
receiving device information of a device that captured the audio data,
wherein determining whether the speech of the audio data includes one or both of near-field speech and far-field speech includes:
determining whether the audio data is captured using a personalized device based on the received device information.

18. A computer-readable storage device storing instructions that, when executed by a computer, cause the computer to perform a method for personalizing speech enhancement components without enrollment in speech communication systems, the method including:
receiving audio data, the audio data including speech, and the audio data to be processed by at least one speech enhancement component:
determining; without requiring a user to enroll, whether the speech of the audio data includes one or both of near-field speech and far-field speech; and
changing one or more of the at least one speech enhancement component based on determining the speech of the audio data includes one or both of near-field speech and far-field speech.

19. The computer-readable storage device according to claim 18, wherein changing the one or more of the at least one speech enhancement component includes:
changing the one or more of the at least one speech enhancement components to one or more speech enhancement components having been trained with near-field speech as clean speech and far-field speech as distracters.

20. The computer-readable storage device according to claim 18, wherein the instructions that, when executed by the computer; cause the computer to perform the method further including:
wherein changing one or more of the at least one speech enhancement component includes:
when the speech of the audio data includes either i) only near-field speech or ii) near-field and far-field speech, changing each of the one or more of the at least one speech enhancement components to corresponding personalized speech enhancement components; and
when the speech of the audio data includes only far-field speech, changing each of the one or more of the at least one speech enhancement components to corresponding speech enhancement components that do not remove far-field speech.
